(19) United States
(12) Patent Application Publication
(10) Pub. No.: US 2009/0167697 A1
(43) Pub. Date: Jul. 2, 2009

(54) FOLDER TYPE PORTABLE TERMINAL AND METHOD FOR SETTING KEY INPUT UNIT THEREOF

(75) Inventors: Norio Okada, Tokyo (JP); Keiichi Minamide, Tokyo (JP); Hideki Hayashi, Tokyo (JP); Jong-Seong Lee, Tokyo (JP)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/326,726

(22) Filed: Dec. 2, 2008

(30) Foreign Application Priority Data
Dec. 27, 2007 (KR) 10-2007-0138140
Jun. 12, 2008 (KR) 10-2008-0055072

(51) Int. Cl. G06F 3/02

(52) U.S. Cl. 345/169

(57) ABSTRACT

A folder type portable terminal and a method for setting a key input unit thereof are disclosed. The folder type portable terminal includes a key input unit, a body, and a folder. The key input unit includes a first key set having a plurality of keys, each key being allocated a dial key to make a call and an alphabet key based on a QWERTY-type letter arrangement, a second key set having alphabet keys, a third key to perform a plurality of functions including making calls, and a fourth key set. The body is equipped with the key input unit. The folder is rotatably coupled to the body with respect to a hinge. At least a part of the key input unit protrudes from the body when the folder rotates with respect to the hinge to be opened with respect to the body.

### CROSS REFERENCE TO RELATED APPLICATION

This application claims priority from and the benefit of Korean Patent Application No. 10-2008-0055072, filed on Jun. 12, 2008, and Korean Patent Application No. 10-2007-0138140, filed on Dec. 27, 2007, which are both hereby incorporated by reference for all purposes as if fully set forth herein.

### BACKGROUND OF THE INVENTION

1. Field of the Invention

The present invention relates to a portable terminal, and more particularly, to a folder type portable terminal having a folder that can be opened in first and second directions and to a method that sets a key table for a voice call as a key input unit when the folder of the portable terminal is opened in the first direction and sets a key table for inputting letters as a key input unit when the folder of the portable terminal is opened in the second direction, which may prevent a key input error.

2. Discussion of the Background

Portable terminals are generally classified as bar type, flip type, folder type, or sliding type according to their appearance.

Bar type terminals are shaped like a bar, or configured to have a single main body housing equipped with a key input unit to input data, a display device to output data, and a transceiver module. Bar type terminals may have an advantage in that their structure is simple.

Flip type terminals include a main body, a flip, and a hinge part that rotatably couples the main body and the flip. Flip type terminals are equipped with the same main body as bar type terminals. Flip type terminals have an advantage in that the flip covers the key input unit in a call waiting mode to prevent unintentional operation of the key input unit.

Sliding type portable terminals are configured so that a slider slides along the main body to open or close the main body, performing corresponding functions. For example, when the slider slides to open the main body, the display is turned on, an incoming call is answered, or a corresponding function key of the plurality of keys in the front side can be pressed.

Folder type portable terminals include a main body, a folder, and a hinge part that rotatably couples the main body and the folder. Folder type portable terminals are in an open or closed state as the folder rotates relative to the main body. When the folder is collapsed onto the main body, the folder type portable terminal is in an idle mode. Also, in that case, the folder covers the key input unit of the main body and prevents the key input unit from being unintentionally pressed. Folder type portable terminals may extend the distance between the transmission part and the reception part in a calling mode, although they are closed in an idle mode.

However, when these folder type portable terminals have a QWERTY-type key input unit, errors may frequently occur at the QWERTY-type key input unit.

The QWERTY-type key input unit employs a variety of key types. When a key input unit for a phone call is input, only the numbers are used. However, if a non-number key is unintentionally pressed, the key input unit may generate errors. Also, as the number of key types increases, the specification and operability of the keys may deteriorate.

### SUMMARY OF THE INVENTION

The present invention provides a folder type portable terminal that may enhance the specification and operability of a key input unit thereof and a method for setting a key input unit of the portable terminal.

The present invention also provides a folder type portable terminal and a method that sets a key input unit to a first key table, which includes number keys and the first function key, when the folder is opened in the first direction and sets the key input unit to a second key table, which includes a QWERTY-type letter key and the second function key, when the folder is opened in the second direction.

The present invention also provides a folder type portable terminal that makes a part of the first key table protrude when the folder is opened in the first direction, and a method for setting a key input unit of the folder type portable terminal.

The present invention also provides a folder type portable terminal thin which only one key of the first key table set as the key input unit, for example, a dial key, protrudes when the folder is opened in the first direction, and in which the dial key and an alphabet key are allocated to one key in the key input unit and the one key is divided by respective key devices.

Additional features of the invention will be set forth in the description which follows, and in part will be apparent from the description, or may be learned by practice of the invention.

The present invention discloses a folder type portable terminal including a key input unit, a body, and a folder. The key input unit includes a first key set having a plurality of keys including dial keys for making a call and alphabet keys based on a QWERTY-type letter arrangement, a second key set having alphabet keys, a third key set to perform a plurality of functions including making calls, and a fourth key set. The body is equipped with the key input unit. The folder is rotatably coupled to the body by a hinge. Here, at least a part of the key input unit protrudes from the body when the folder is rotated with respect to the hinge and opened with respect to the body.

The present invention discloses a method for setting a key input unit in a folder type portable terminal that includes a body having a key input unit and a folder that is rotatably coupled to the body and opened with respect to the body. The key input unit includes a first key set having a plurality of keys including dial keys to make a call and alphabet keys based on a QWERTY-type letter arrangement, a second key set having alphabet keys, a third key set to perform a plurality of functions including making calls, and a fourth key. The method includes determining whether the folder is opened with respect to the body and setting the key input unit to a preset key table when the folder is opened.

The present invention also discloses a folder type portable terminal including a body, a key input unit, a hinge, a coupling member, and a folder. The key input unit is disposed in the body and includes a first key set having a plurality of keys, each key being allocated a dial key to make a call and an alphabet key based on a QWERTY-type letter arrangement, a second key set having alphabet keys, a third key set to perform a plurality of functions including making calls, and a fourth key set. The coupling member is located between the hinge and the key input unit, and the folder is rotatably coupled to the body by the hinge. Linear motion of the coupling member causes at least a part of the key input unit to protrude from the body when the folder rotates about the hinge to be open with respect to the body, and linear motion of the coupling member causes the at least a part of the key input unit to be inserted into the body when the folder rotates about the hinge to be closed with respect to the body.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic block diagram showing a portable terminal according to an exemplary embodiment of the present invention.

FIG. 2 is a flow chart describing a method for setting a key input unit of a portable terminal according to an exemplary embodiment of the present invention.

FIG. 3 is a plan view showing a portable terminal having a folder opened in a first direction, according to a first exemplary embodiment of the present invention.

FIG. 4A, FIG. 4B, FIG. 4C, and FIG. 4D are cross-sectional views of a key input unit of a portable terminal as the folder is opened/closed in the first direction, according to the first exemplary embodiment of the present invention.

FIG. 5 is a plan view showing a portable terminal having a folder opened in a second direction, according to the first exemplary embodiment of the present invention.

FIG. 6 is a plan view showing a portable terminal having a folder opened in a first direction, according to a second exemplary embodiment of the present invention.

FIG. 7A, FIG. 7B, FIG. 7C, and FIG. 7D are cross-sectional views of a key input unit of a portable terminal as the folder is opened/closed in the first direction, according to the second exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Although exemplary embodiments of the present invention are described based on portable terminals, the present invention is not limited thereto. The portable terminals according to exemplary embodiments of the present invention include a QWERTY-type key input unit and have folders that open and close in first and second directions. It will, however, be appreciated that the present invention may be applied to all information communication devices, multimedia devices, and their applications, such as, a mobile communication terminal, a mobile phone, a wired/wireless phone, a portable multimedia player (PMP), a personal digital assistant (PDA), and a smart phone.

### Exemplary Embodiment 1

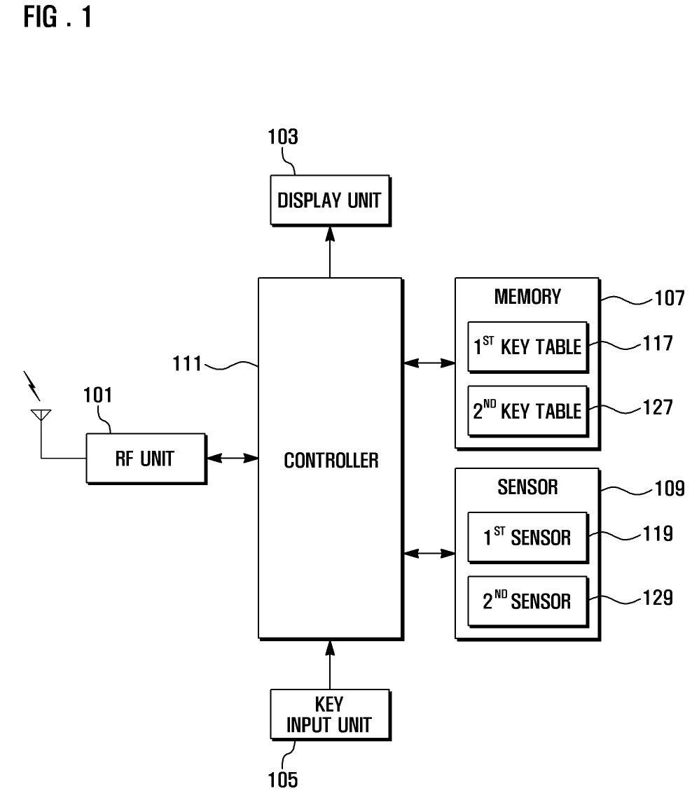

FIG. 1 is a schematic block diagram showing a portable terminal according to an exemplary embodiment of the present invention.

Referring to FIG. 1, the portable terminal includes an RF unit 101, a display unit 103, a key input unit 105, a memory 107, a sensor 109, and a controller 111.

The RF unit 101 performs RF communication for the portable terminal. The RF unit 101 is configured to include an RF transmitter to up-convert the frequency of transmitted signals and amplify the transmitted signals and an RF receiver to low-noise amplify of received RF signals and down-convert the frequency of the received RF signals.

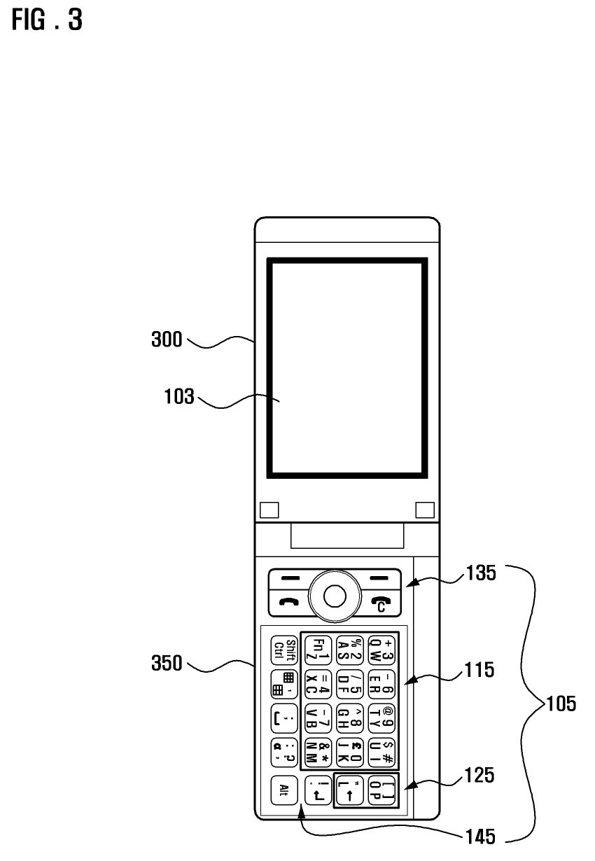

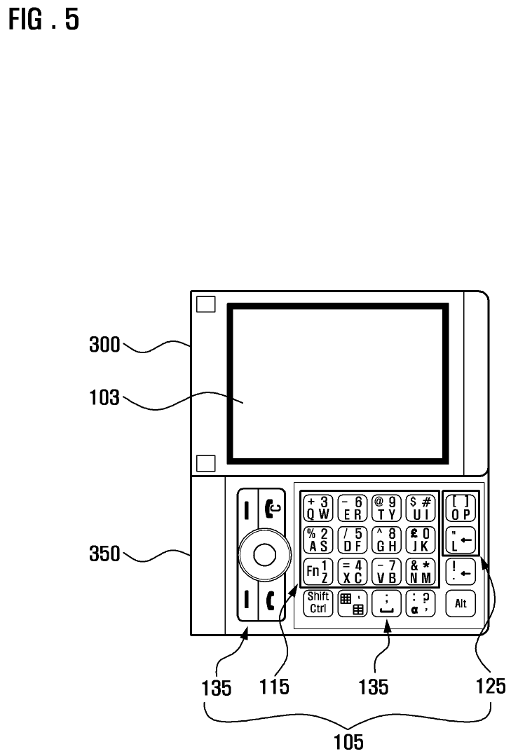

The display unit 103 displays a variety of information related to the state and operation of the portable terminal. The display unit 103 displays information about operations when the folder is opened in a first direction or a second direction. The display unit 103 displays information for a phone call when the folder is opened in the first direction as shown in FIG. 3. The display unit 103 displays information about operations, such as inputting letters, TV viewing, browsing, and email writing, when the folder is opened in the second direction as shown in FIG. 5. Here, the first direction refers to the direction where the folder is opened away from the main body of general portable terminals so that the folder is arranged in a lengthwise direction. The second direction refers to a direction perpendicular to the first direction, where the folder is opened away from the main body and arranged in a widthwise direction.

The key input unit 105 receives user's commands to operate the portable terminal. The key input unit 105 has a QWERTY type letter arrangement.

The key input unit 105 includes first, second, third, and fourth key sets 115, 125, 135, and 145, as shown in FIG. 3. The first key set 115 includes dial keys, which are composed of number keys, to make phone calls, alphabet keys to input letters, and special letter keys. The first key set 115, as shown in FIG. 3, may include keys arranged in a 3×4 matrix at the upper right of the key input unit 105. The second key set 125 may include keys similar to those of the first key set 115. For example, the second key set 125 may include alphabet keys and special letter keys, but not dial keys. The third key set 135 may include keys related to making a phone call, such as a navigation-related key, a call key, a call termination key, a confirmation key, and a menu key. The third key set 135 may be at the uppermost portion of the key input unit 105. The fourth key set 145 may include special keys and non-character keys. Here, non-character keys may be function keys, shift keys, and enter keys. The first and third key sets 115 and 135 may have an integral form. Similarly, the second and fourth key sets 125 and 145 may have an integral form.

When the folder is opened in the first direction, the key input unit 105 is set to be the first key table 117 of the memory 107. That is, when the folder is opened in the first direction, the key input unit 105 is set so that dial keys of the first key set 115 are available and the third key set is available. When the folder is opened in the first direction, if a key to which the number “1” and the letter “Z” are allocated is pressed, only an input corresponding to the number “1” is conducted. This is because the folder was opened in the first direction to make a phone call and accordingly the third key set 135 was activated.

When the folder is opened in the first direction, the first and third key sets 115 and 135 protrude from the portable terminal. That is, the first and third key sets 115 and 135, set as the first key table 117, protrude up from the main body 350 of the portable terminal so as to be distinguished from other keys and to prevent the pressing of other keys, which may prevent portable terminal errors.

When the folder is opened in the second direction, the key input unit 105 is set to be the second key table 127 of the memory 107. That is, when the folder is opened in the second direction, the key input unit 105 is set so that the QWERTY-type alphabet keys for inputting letters of the first key set 115 are available and the second and fourth key sets 125 and 145 are available. When the folder is opened in the second direction, if a key to which the number “1” and the letter “Z” are allocated is pressed, only an input corresponding to the letter “Z” is conducted. Also, when the key is also allocated a special character in addition to the number “1” and the letter “Z,” an input corresponding to the special character may be conducted. The key input unit 105 may be set so that the third key set 135 is available on demand.

The key input unit 105 is not limited to the arrangement of dial keys, alphabet keys, special keys, and non-character keys shown in FIG. 3 and FIG. 5. For example, regarding one key, numbers and the QWERTY type letters may be perpendicularly arranged. In that case, when the folder is opened in the first direction, a user may view the dial keys in the correct direction and the QWERTY type letters are perpendicular to the arrangement of the dial keys. On the contrary, when the folder is opened in the second direction, a user may view the QWERTY type letter in the correct direction and the dial keys may be perpendicular to the arrangement of the QWERTY type letters. Therefore, when the dial keys arrangement and the QWERTY type letters arrangement are perpendicular to each other, a user may view the keys that are available in the correct direction according to which direction the folder is opened.

Although the key input unit 105, according to an exemplary embodiment of the present invention, has a key arrangement having a 4×5 matrix form with dial keys arranged at the upper right thereof (when the folder is opened in the first direction), it should be understood that the present invention is not limited thereto.

The memory 107 stores information and programs necessary for the operation of the portable terminal. The memory 107 includes the first key table 117 and the second key table 127. The first key table 117 is designed to set the key input unit 105 when the folder is opened in the first direction. The first key table 117 allows dial keys in the first key set 115 to be available and allows the third key set 135 to be available. The second key table 127 is set to be the key input unit 105 when the folder is opened in the second direction. The second key table 127 allows alphabet keys in the first key set 115 to be available and allows the second and fourth key sets 125 and 145 to be available.

The sensor 109 detects the direction in which the folder is opened and includes a first sensor 119 and a second sensor 129. The first and second sensors 119 and 129 may be arranged parallel to the length of the body 350. Also, the first sensor 119 may be located at a lower end of the body 350 and the second sensor 129 may be located at an upper end or vice versa.

The first and second sensors 119 and 129 may each be a magnetic sensor. In that case, the folder may be equipped with respective magnets (not shown) at positions thereof that face the body 350. The first and second sensors 119 and 129, which are installed to the body 350 of the portable terminal, detect whether the folder is opened or closed with respect to the body. That is, the sensors 119 and 129 detect the magnets when the folder is closed onto the body 350, but not when the folder is opened.

The controller 111 controls the overall operation of the portable terminal. The controller 111 sets the key input unit 105. The controller 111 determines, through the sensor 109, the direction in which the folder is opened. When the folder is opened in the first direction, the controller 111 sets the key input unit 105 to be the first key table 1 17. Also, when the folder is opened in the second direction, the controller 111 sets the key input unit 105 to be the second key table 117. The controller 111 displays information on the display unit 103 according to the direction in which the folder is opened.

When the controller 111 determines that the folder is opened in the first direction and accordingly sets the key input unit 105 so that the third key set 135 and the dial keys of the first key set 115 are available, it may set the key input unit 105 so that the alphabet keys of the first key set 115 are available by selecting an option. That is, the controller 111 may allow the key input unit 105 to change and operate its function from the dial keys to the alphabet keys according to a user's selection. This allows user to input letters to the key input unit 105 while the folder is opened in the first direction to make a call.

In addition, when the controller 111 determines that the folder is opened in the second direction and sets the key input unit 105 so that the alphabet keys of the first key set 115 and the second and fourth key sets 125 and 145 are available, it may set the key input unit 105 to change its function from the alphabet keys of the first key set 115 to the dial keys. This is to provide a user with the convenience of inputting numbers in the key input unit 105 while the folder is opened in the first direction to allow for a letter inputting operation.

When the key input unit 105 is set as the second key table 127, the controller 111 may set the key input unit 105 to allow for the third key set 135 to be available.

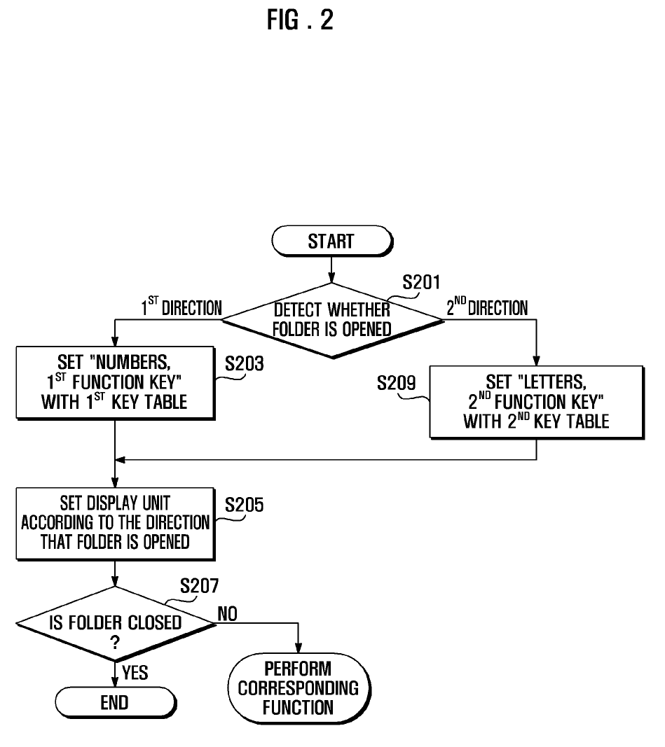

In the following description, a method is explained in which a key input unit of the portable terminal is set, according to a first exemplary embodiment of the present invention. FIG. 2 is a flow chart describing a method for setting a key input unit of a portable terminal according to an exemplary embodiment of the present invention.

Referring to FIG. 1 and FIG. 2, the controller 111 detects whether the folder of the portable terminal is opened through the sensor 109 (S201). The folder may be opened with respect to the body of the portable terminal in the first direction to allow the portable terminal to make a call or in the second direction to allow it to perform operations, such as inputting letters.

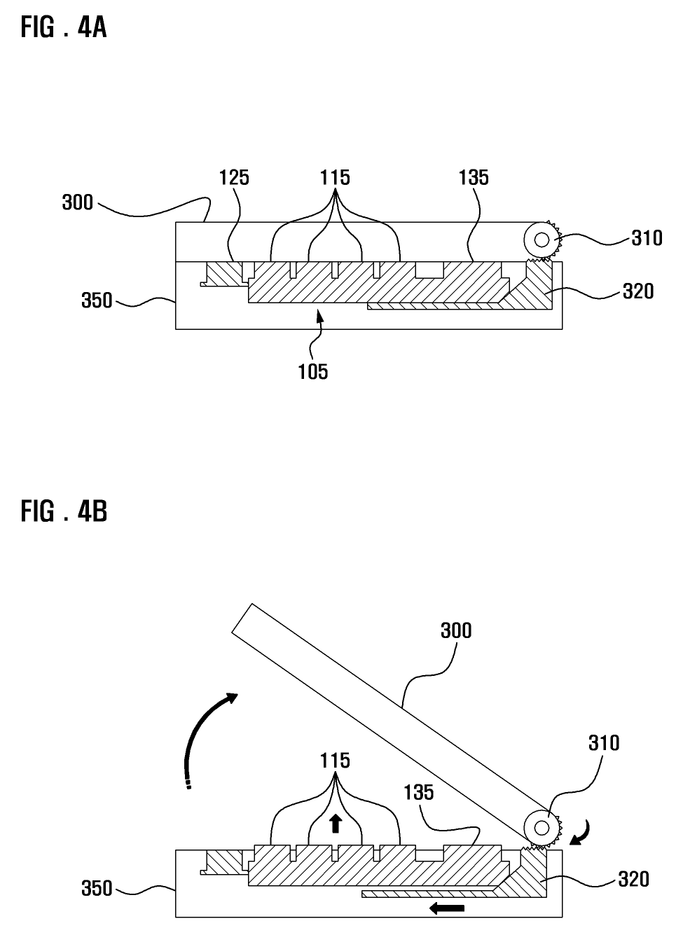

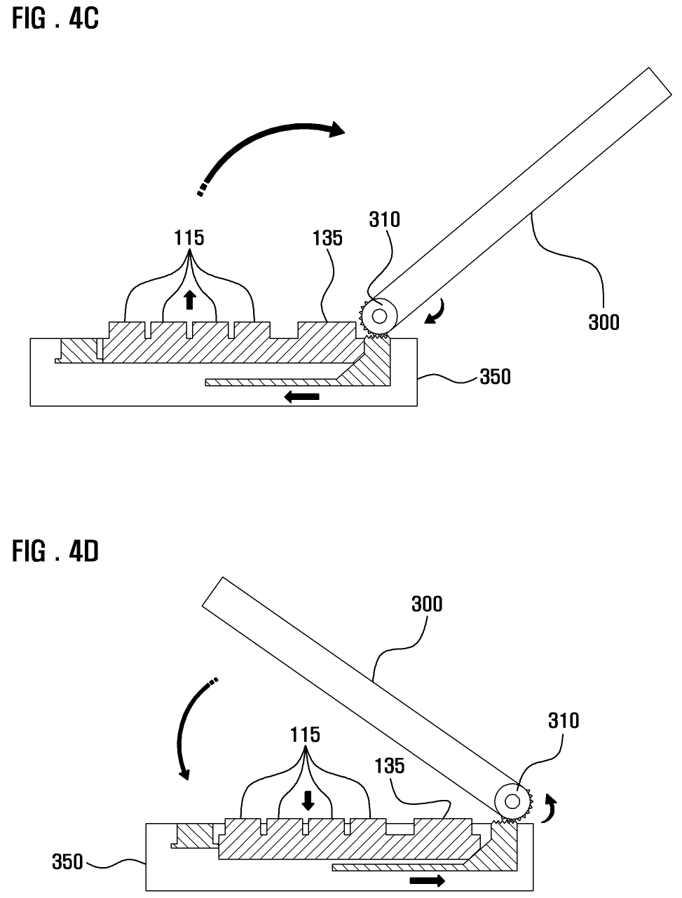

When the controller 111 determines that the folder is opened in the first direction at S201, it sets the key input unit 105 to the first key table 117 (S203). The controller 111 sets the key input unit 105 so that the third key set 135 and the dial keys of the first key set 115 are available. That is, the controller 111 deactivates all the keys other than the keys required for operations, such as making a call. A physical force generated when the folder is opened cause the first and second key sets 115 and 135 to protrude up from the body 350 of the portable terminal, which is shown in FIG. 4A, FIG. 4B, FIG. 4C, and FIG. 4D.

When the controller 111 determines that the folder is opened in the second direction at S201, it sets the key input unit 105 to be the second key table 127 (S209). The controller 111 sets the key input unit 105 so that the alphabet keys of the first key set 115 and the second and fourth key sets 125 and 145 are available. That is, the controller 111 deactivates all the keys other than the keys required for operations, such as email writing or TV viewing. Here, the second key table 127 may further include the third key set 135. In that case, the controller 111 sets the key input unit 105 so that all the keys other than the alphabet keys are available. That is, the controller 111 sets the key input unit 105 so that the alphabet keys of the first key set 115, and the second, third, and fourth key sets 125, 135, and 145 are available.

When the key input unit 105 is set as step S203 or S209, the controller 111 sets the display unit 103 according to the direction that the folder is opened (S205). When the folder is opened in the first direction, the controller 111 displays information about functions, such as making calls, on the display unit 103. When the folder is opened in the second direction, the controller 111 displays information related to a letter input function on the display unit 103. It also rotates the information, which was oriented in the first direction, by 90° and displays it on the display unit 103.

After that, the controller 111 determines whether the folder is closed with respect to the body (S207). When the folder is closed at S207, the controller 111 terminates the current function. On the contrary, when the controller 111 determines that the folder is not closed at S207, it performs a corresponding function requested by a user.

In the following description, a method is explained in which a key input unit is set when the folder of the portable terminal is opened in the first direction. FIG. 3 is a plan view showing a portable terminal having a folder that is opened in a first direction, according to a first exemplary embodiment of the present invention.

Referring to FIG. 3, the portable terminal includes a folder 300 and a body 350. The folder 300 is equipped with a display unit 103, and the body 350 is provided with a key input unit 105. The folder 300 may be further equipped with a sensor 109 or a speaker. The body 350 may be further equipped with a controller 111, a memory 107, a sensor 109, or a microphone.

FIG. 3 shows a portable terminal having folder 300 that is opened in the first direction. That is, the folder 300 is opened in the lengthwise direction of the portable terminal to make a call. In that case, the key input unit 105 is set so that the dial keys of the first key set 115 are available and the third key set 135 is available. The key input unit 105, which is set as the first key table 117, protrudes up from the body 350 by a physical force generated as the folder 300 is opened, as shown in FIG. 4A, FIG. 4B, FIG. 4C, and FIG. 4D. FIG. 4A, FIG. 4B, FIG. 4C, and FIG. 4D are cross-sectional views of a key input unit of a portable terminal as the folder is opened/closed in the first direction, according to a first exemplary embodiment of the present invention.

FIG. 4A is a side view of the portable terminal having a folder 300 that is closed. The folder 300 is coupled to the body 350 by a hinge 310. The hinge 310 includes a first hinge to open the folder 300 in the first direction and a second hinge to open the folder 300 in the second direction. The first and third key sets 115 and 135 may be integrally formed and installed within the body 350. The second key set 125 may also installed within the body 350 but spaced apart from the first and third key sets 115 and 135. The fourth key set 145, not shown, may be integrally formed with the second key set 125 and installed within the body 250. A coupling member 320 may be located between the hinge 310 and the integrally formed first and third key sets 115 and 135. The hinge 310 and the coupling member 320 may be a rack and a pinion, respectively. The rack and the pinion are a pair of gears, composed of a rack gear and a pinion gear. The rack is referred to as a rack gear or a linear gear, which is manufactured as teeth machined on a flat bar. The pinion is referred to as a pinion gear, which is manufactured as teeth machined on the periphery of a wheel and engages the rack gear. Therefore, the rack and pinion coverts rotational motion to linear motion. For example, the rotation motion of the pinion causes the rack to move linearly and the linear motion of the rack causes the pinion to rotate.

In an exemplary embodiment of the present invention, the hinge 310 may be a pinion and the coupling member 320 may be a rack. Therefore, opening the folder causes the hinge 310 to rotate and this rotational motion of the hinge 310 causes the linear motion of the coupling member 320. A series of these operations causes the key input unit 105 to protrude from the body 350, which is shown in FIG. 4B and FIG. 4C.

It should be understood that the structures of the hinge 310 and the coupling member 320 are not limited to a rack and a pinion. For example, the folder 300 may be modified to further equip other elements as well as the hinge 310 and the coupling member 320.

Although the first and third key sets 115 and 135 of the exemplary embodiment are integrally formed and protrude from the body when the folder 300 is opened in the first direction, it should be understood that the present invention is not limited thereto. For example, the exemplary embodiment may be modified in such a way that only the first key set 115, set as the dial keys, protrudes from the body of the portable terminal.

FIG. 4B shows a side view of the portable terminal whose folder 300 is in the process of opening. While the folder 300 is opening, its hinge 310 rotates and the coupling member 320 moves linearly. More specifically, since the coupling member 320 has a sloped portion that contacts a part of block that is integrally formed by the first and third key sets 115 and 135 while the folder 300 is opening clockwise, the hinge 310 rotates clockwise and thus the coupling member 320 moves linearly to the left, so that the sloped portion pushes the first and third key sets 115 and 135 and accordingly the first and the third key sets 115 and 135 move up and protrude from the body 350.

FIG. 4C shows a side view of the portable terminal whose folder 300 is completely opened. When the folder 300 is fully opened, the hinge 310 rotates and stops at its maximum rotation angle. This causes the greatest movement distance of the coupling member 320. Therefore, the first and third key sets 115 and 135 of the key input unit 105 completely protrude up from the body 350 of the portable terminal.

FIG. 4D shows a side view of the portable terminal whose folder 300 is in the process of closing. This process is performed opposite to that of FIG. 4B. More specifically, when the folder 300 rotates counterclockwise from the fully opened state to the closed state, the hinge 310 rotates counterclockwise and accordingly the coupling member 320 moves linearly to the right. Therefore, the first and third key sets 115 and 135 are lowered down and inserted into the body 350.

In the following description, a method in which a key input unit is set when the folder of the portable terminal is opened in the second direction is described. FIG. 5 is a plan view showing a portable terminal whose folder is opened in a second direction, according to a first exemplary embodiment of the present invention.

In FIG. 5, the second direction refers to a widthwise direction of the portable terminal, perpendicular to the first direction described above. The folder is opened in the second direction to allow the portable terminal to perform letter inputting, TV viewing, browsing, and email writing. In this case, the key input unit 105 is set so that the alphabet keys of the first key set 115 and the second and fourth key sets 125 and 145 are available. Also, the key input unit 105 may be set so that the third key set 135 is available according to an operated function.

### Exemplary Embodiment 2

In the following description, a detailed description of elements, identical to or corresponding to those included in Exemplary Embodiment 1, is omitted.

Although Exemplary Embodiment 2 is similar to Exemplary Embodiment 1, it differs in that dial keys and alphabet keys, allocated to one key in the key input unit, are spaced apart by respective key devices and accordingly only dial keys of the first key set protrude from the key input unit when the folder is opened in the first direction.

When the folder is opened in the second direction, the portable terminal, according to Exemplary Embodiment 2, is operated the same as that of Exemplary Embodiment 1 and thus a detailed description thereof is omitted in the following description.

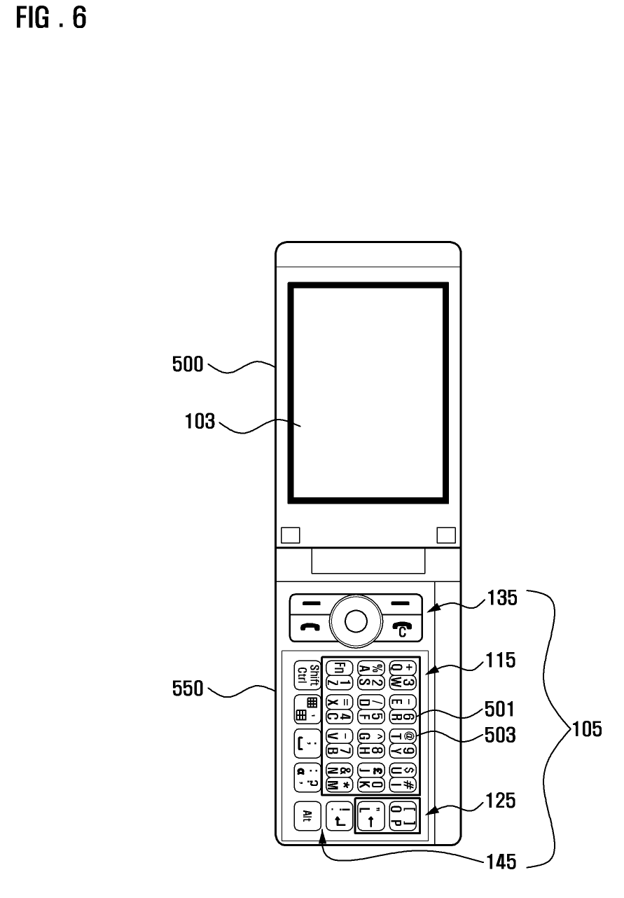

As shown in FIG. 6, the key input unit 105 includes first, second, third, and fourth key sets 115, 125, 135,and 145. The first key set 115 includes a plurality of keys divided from each other by the first and second key devices 501 and 503. That is, the first key set 115 includes the first key devices 501, which are dial keys for making a call, and the second key devices 503, which are not dial keys. The first key devices 501 are integrally formed with the third key set 135. The second key devices 503 are integrally formed with the second and fourth key sets 125 and 145.

The key input unit 105 is set as the first key table 117 when the first folder is opened in the first direction and as the second key table 127 when the first folder is opened in the second direction. In particular, when the folder is opened in the first direction, the first key device 501 of the first key set 115 protrudes from the body 350 of the portable terminal and the third key set 135 also protrudes. That is, the third key set 135 and the first key device 501 to which dial keys of the first key set 115 are allocated protrude from the body 550 so as to differ from other keys, thereby prevent the other keys from being unintentionally pressed. In particular, since only the first key device 501 of the first key set 115, to which dial keys are allocated, protrudes from the body, the key input unit 105 may prevent the other keys from being unintentionally pressed.

The memory 107 includes a first key table 117 and a second key table 127. The first key table 117 is set as the key input unit 105 when the folder is opened in the first direction. That is, the first key table 117 allows dial keys of the first key set 115, i.e., the first key device 501, and the third key set 135 to be available in the key input unit 105. The second key table 127 is set to be the key input unit 105 when the folder is opened in the second direction. That is, the second key table 127 allows alphabet keys of the first key set 115 and the second and fourth key sets 125 and 145 to be available in the key input unit 105.

The controller 111 detects which direction the folder is opened through the sensor 109. The controller 111 sets the key input unit 105 to be the first key table 117 when the folder is opened in the first direction and to be the second key table 127 when the folder is opened in the second direction. The controller 111 displays information on the display unit 103 according to the direction in which the folder is opened.

When the controller 111 determines that the folder is opened in the first direction and sets the key input unit 105 so that the third key set 135 and the first key device 501 of the first key set 115 are available, it may set the key input unit 105 so that the second key device 503 of the first key set 115 is available by selecting an option. In addition, when the controller 111 determines that the folder is opened in the second direction and sets the key input unit 105 in so that alphabet keys of the first key set 115 and the second and fourth key sets 125 and 145 are available, it may set the key input unit 105 so that the dial keys of the first key set 115 are available.

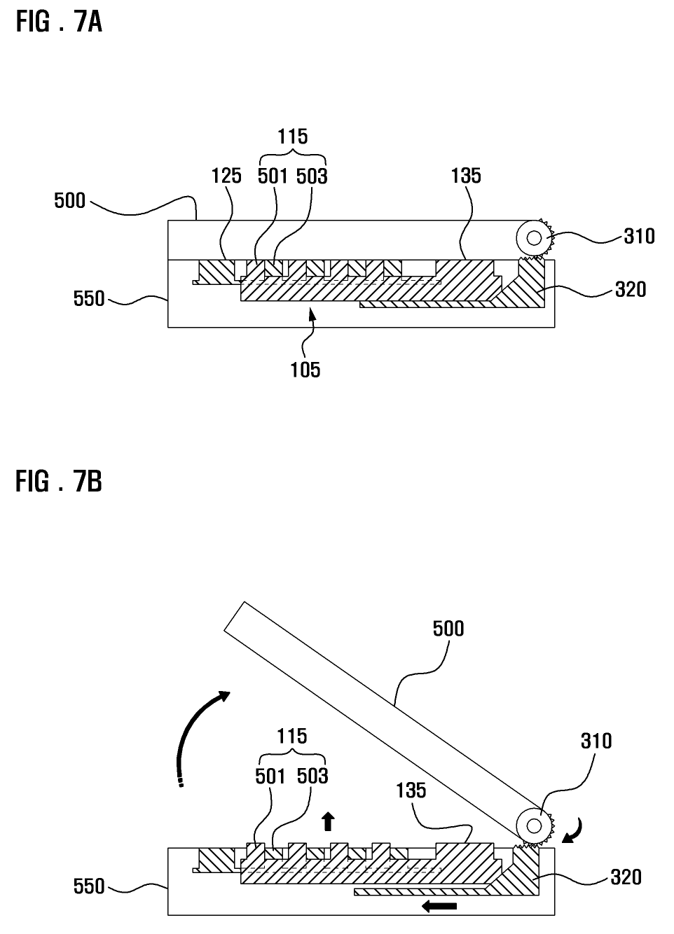

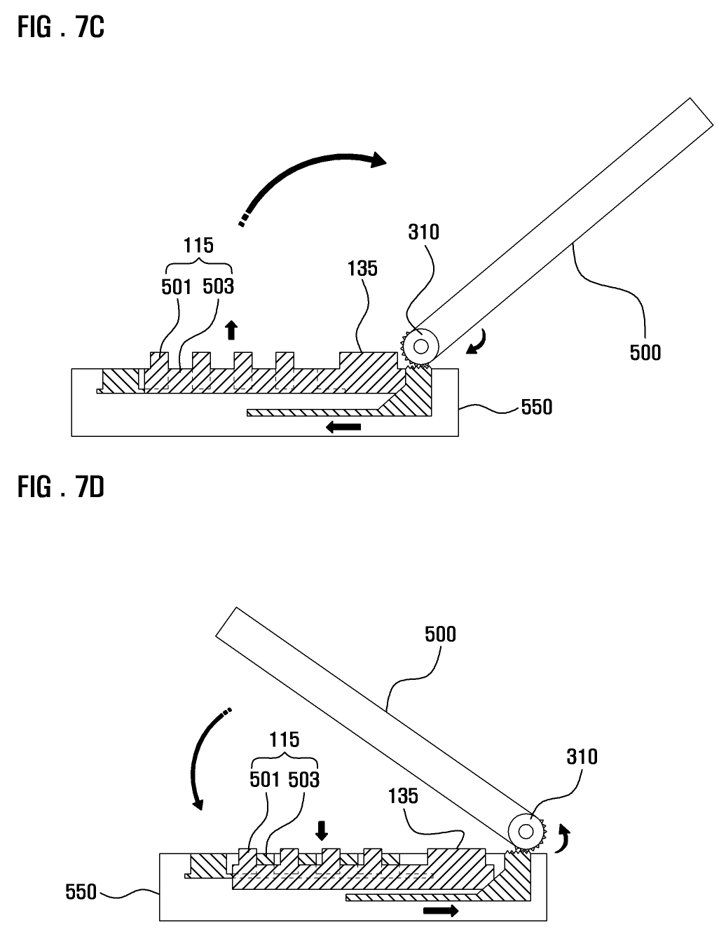

In the following description, a method in which a key input unit of the portable terminal is set, according to a second exemplary embodiment of the present invention, is explained. The method for setting a key input unit, according to the second exemplary embodiment, includes the same steps as the first exemplary embodiment as shown in FIG. 1 and FIG. 2, except for the following steps. That is, when the controller 111 sets the key input unit 105 to the first key table 117 at S203, a physical force due to the rotation of the folder causes the third key set 135 and the first key device 501 of the first key set 115 to protrude up from the body of the portable terminal, which is shown in FIG. 7A, FIG. 7B, FIG. 7C, and FIG. 7D.

In the following description, a method in which a key input unit is set when the folder is opened in the first direction, according to a second exemplary embodiment of the present invention. FIG. 6 is a plan view showing a portable terminal having a folder that is opened in a first direction, according to a second exemplary embodiment of the present invention.

Referring to FIG. 6, the portable terminal includes a folder 500 and a body 550. When the folder 500 is opened in the first direction, the third key set 135 and the dial keys of the first key set 115 are set to be available in the key input unit 105. A physical force due to the rotation of the folder 500 causes parts of the key input unit 105, which are set as the first key table 117, to protrude up from the body 550. That is, the third key set 135 and the first key device 501 of the first key set 115 are raised from the body 550. A series of these operations is described, as follows, with reference to FIG. 7A, FIG. 7B, FIG. 7C, and FIG. 7D.

FIG. 7A, FIG. 7B, FIG. 7C, and FIG. 7D are cross-sectional views of a key input unit of a portable terminal as the folder is opened/closed in the first direction, according to a second exemplary embodiment of the present invention.

FIG. 7A is a side view of the portable terminal whose folder 500 is closed. The folder 500 is coupled to the body 550 by a hinge 310. The third key set 135 and the first key device 501 of the first key set 115 are integrally formed and installed within the body 550. Also, the second key device 503 of the first key set 115 and the second and fourth key sets 125 and 145 are integrally formed and installed in the body 550.

Although the present exemplary embodiment is implemented so that the third key set 135 and the first key device 501 of the first key set 115 are integrally formed and protrude from the body 550 when the folder 500 is opened in the first direction, it should be understood that the present invention is not limited thereto. For example, the exemplary embodiment may be modified in such a way that only the first key device 501, to which dial keys are allocated, protrudes.

FIG. 7B shows a side view of the portable terminal whose folder 500 is in the process of opening. While the folder 500 is opening, its hinge 310 rotates and the coupling member 320 moves linearly. Since the coupling member 320 has a sloped portion that contacts a part of the block, which is integrally formed by the third key set and the first key device 501 of the first key set 115, when the coupling member 320 moves linearly, the first key device 501 and the third key set 135 are raised from the body 550.

FIG. 7C shows a side view of the portable terminal whose folder 500 is completely opened. When the folder 500 is fully opened, the hinge 310 rotates and stops at its maximum rotation angle and this causes the greatest movement distance of the coupling member 320. Therefore, the first key device 501 and the third key set 135 completely protrude up from the body 550 of the portable terminal.

FIG. 7D shows a side view of the portable terminal whose folder 500 is in the process of closing. This process is performed opposite to that of FIG. 7B. More specifically, when the folder 500 rotates opposite to the rotation direction in FIG. 7B, the coupling member 320 moves opposite to the direction in FIG. 7B. Therefore, the first key device 501 and the third key set 135 are lowered down and inserted to the body 550.

Although the folder type portable terminal and a method for setting a key input unit, according to exemplary embodiments of the present invention, have keys that are raised from the body of the portable terminal when the folder is opened in the first direction, it should be understood that the present invention is not limited thereto. For example, the exemplary embodiments may be modified so that the keys are raised from the body when the folder is opened in the second direction.

The folder type portable terminal and a method for setting a key input unit, according to exemplary embodiments of the present invention, are explained based on the key input unit having a QWERTY-type letter arrangement, however, it will be easily appreciated that the present invention may be applied to portable terminals equipped with key input units having a variety of key arrangements.

As described above, the folder type portable terminal of exemplary embodiments of the present invention may set its key input unit according to the use purposes thereof and thus prevent the key input errors, which may enhance the terminal's convenience and operability.

In particular, since the third key set of the folder type terminal, which is used for a dial key and a function key for a phone call, may protrude when the folder is opened in the first direction, it may prevent keys from being pressed unintentionally. If one key to which a dial key and an alphabet key are allocated is divided by respective key devices, only the dial key protrudes when the folder is opened in the first direction, and thus key input errors may be prevented.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A folder type portable terminal, comprising:
a key input unit, the key input unit comprising a first key set having a plurality of keys, each key being allocated a dial key to make a call and an alphabet key based on a QWERTY-type letter arrangement, a second key set having alphabet keys, a third key set to perform a plurality of functions including making calls, and a fourth key set;
a body equipped with the key input unit; and
a folder rotatably coupled to the body by a hinge,
wherein at least a part of the key input unit protrudes from the body when the folder rotates about the hinge to be opened with respect to the body.

2. The folder type portable terminal of claim 1, wherein the folder is rotatably coupled to the body by a first hinge and a second hinge, the folder being rotatable about the first hinge in a first direction and rotatable about the second hinge in a second direction.

3. The folder type portable terminal of claim 2, further comprising a controller to set the key input unit to be a first key table when the folder is opened in the first direction and to be a second key table when the folder is opened in the second direction.

4. The folder type portable terminal of claim 3, wherein:
the first key table comprises the third key set and the dial keys of the first key set; and
the second key table comprises the alphabet keys of the first key set, the second key set, and the fourth key set.

5. The folder type portable terminal of claim 4, wherein the first key set is raised from the body when the folder is opened in the first direction.

6. The folder type portable terminal of claim 4, wherein:
the first key set and the third key set are integrally formed; and
the second key set and the fourth key set are integrally formed.

7. The folder type portable terminal of claim 4, wherein:
each key in the first key set comprises a portion of a first key device and a portion of a second key device, the first key device corresponding to dial keys and the second key device corresponding to keys other than the dial keys; and
the first key device and the second key device are spaced apart from each other.

8. The folder type portable terminal of claim 7, wherein the first key set is raised from the body when the folder is opened in the first direction.

9. The folder type portable terminal of claim 7, wherein:
the third key set and the first key device of the first key set are integrally formed; and
the second key device of the first key set, the second key set, and the fourth key set are integrally formed.

10. The folder type portable terminal of claim 1, wherein the key input unit does not protrude from the body when the folder is closed.

11. A method for setting a key input unit in a folder type portable terminal comprising a body having a key input unit and a folder that is rotatably coupled to the body and opens with respect to the body, where the key input unit comprises a first key set comprising a plurality of keys, each key being allocated a dial key to make a call and an alphabet key based on a QWERTY-type letters, a second key set having alphabet keys, a third key set to perform a plurality of functions including making calls, and a fourth key set, the method comprising:
determining whether the folder is opened with respect to the body; and
setting the key input unit to a specific key table when the folder is opened.

12. The method of claim 11, wherein the determination comprises:
determining whether the folder is opened away from the body in a first direction or a second direction.

13. The method of claim 12, wherein setting the key input unit comprises:
setting the key input unit to be a first key table when the folder is opened in the first direction; and
setting the key input unit to be a second key table when the folder is opened in the second direction.

14. The method of claim 13, wherein:
the first key table is the third key set and the dial keys of the first key set; and
the second key table is the alphabet keys of the first key set, the second key set, and the fourth key set.

15. The method of claim 13, further comprising:
setting a display direction of a display unit according to which direction the folder is opened; and
displaying information on the display unit.

16. A folder type portable terminal, comprising:
a body;
a key input unit disposed in the body, the key input unit comprising a first key set having a plurality of keys, each key being allocated a dial key to make a call and an alphabet key based on a QWERTY-type letter arrangement, a second key set having alphabet keys, a third key set to perform a plurality of functions including making calls, and a fourth key set;
a hinge;
a coupling member located between the hinge and the key input unit; and
a folder rotatably coupled to the body by the hinge,
wherein linear motion of the coupling member causes at least a part of the key input unit to protrude from the body when the folder rotates about the hinge to be open with respect to the body, and
wherein linear motion of the coupling member causes the at least a part of the key input unit to be inserted into the body when the folder rotates about the hinge to be closed with respect to the body.

17. The folder type portable terminal of claim 16, wherein one of the coupling member and the hinge is a rack and the other of the coupling member and the hinge is a pinion.

18. The folder type portable terminal of claim 16, wherein the hinge comprises a first hinge and a second hinge, the folder being rotatable about the first hinge in a first direction and rotatable about the second hinge in a second direction.
